(19) United States
(12) Patent Application Publication
(10) Pub. No.: US 2008/0278337 A1
(43) Pub. Date: Nov. 13, 2008

(54) URINE DETECTION SYSTEM AND METHOD

(75) Inventors: Tsun-Che Huang, Tainan City (TW); Tzong-Che Ho, Hsinchu City (TW); Chun-Hsun Chu, Tainan City (TW); Kevin Lee, Taipei County (TW)

Correspondence Address: QUINTERO LAW OFFICE, PC, 2210 MAIN STREET, SUITE 200, SANTA MONICA, CA, 90405, US

(73) Assignee: INDUSTRIAL TECHNOLOGY RESEARCH INSTITUTE, HSINCHU (TW)

(21) Appl. No.: 11/966,880

(22) Filed: Dec. 28, 2007

(30) Foreign Application Priority Data
May 10, 2007 (TW) TW96116655

(51) Int. Cl. G08B 23/00

(52) U.S. Cl. 340/573.5

(57) ABSTRACT

A urine detection system is provided for detecting degree of wetness of a diaper, comprising a plane printing electrode, a sensor, and a display unit. The plane printing electrode comprises a first electrode area and a second electrode area. The sensor comprises a first sensor electrode, a second sensor electrode and a processor. Wherein the first sensor electrode and the first electrode area forms a first capacitor, and the second sensor electrode and the second electrode area forms a second capacitor. The processor, detects capacitance of the first and second capacitors, and determines a signal representing degree of wetness of the diaper. The display unit receives the signal and displays the degree of wetness corresponding to the signal.

### BACKGROUND

The invention relates to medical care systems, and more particularly to a system for detecting degree of wetness of a diaper and corresponding urinating frequency.

Various techniques and devices have been developed for urine detection.

For example, U.S. Pat. No. 6,916,968 discloses a urine detection system for detecting urine excretion, such as in a diaper, clothing, and bedding. According to the resonating-reflecting wetness detection utilized in the urine detection system of U.S. Pat. No. 6,916,968, the operating distance is 20 mm-40 mm. Accordingly, when the distance between a receiver and a detector exceeds 40 mm, detection accuracy declines as signal weakens. In addition, when amount of liquid present in the test subject increases, the operating distance becomes shorter, even shorter than 40 mm.

For another example, U.S. Pat. No. 7,049,969 discloses a liquid detection sensor, which has an operating distance longer then that of the urine detection system of U.S. Pat. No. 6,916,968. The liquid detection sensor of U.S. Pat. No. 7,049,969, however, is implemented by a complicated structure, and utilizes higher output power (generally mW level).

Hence, there is a need for a urine detection system and method, better addressing the described problems arising from existing technology.

This section is intended to introduce the reader to various aspects of the art, which may be related to various aspects of the invention, which are described and/or claimed below. This discussion is believed to be helpful in providing the reader with background information to facilitate a better understanding of the various aspects of the invention. Accordingly, it should be understood that these statements are to be read in this light, and not as admissions of related art.

### SUMMARY

Certain aspects commensurate in scope with the originally claimed invention are set forth below. It should be understood that these aspects are presented merely to provide the reader with a brief summary of certain forms the invention might take and that these aspects are not intended to limit the scope of the invention.

A urine detection system is provided for identifying degree of wetness of a diaper. The urine detection system comprises a plane printing electrode, a sensor, and a display unit. The plane printing electrode comprises a first electrode area and a second electrode area. The sensor comprises a first sensor electrode, a second sensor electrode, and a processor. The first sensor electrode and the first electrode area constitute a first capacitor, and the second sensor electrode and the second electrode area constitutes a second capacitor. The second sensor electrode and the second electrode area constitute a second capacitor. The processor detects capacitance of the first and second capacitors, and determines a wetness signal representing the degree of wetness of the diaper. The display unit receives the wetness signal and displays the degree of wetness corresponding to the wetness signal.

A urine detection method is provided for identifying degree of wetness of a diaper. A plane printing electrode is provided on an inside surface of the diaper, wherein the plane printing electrode comprises a first electrode area and a second electrode area. A first sensor electrode and a second sensor electrode are provided on an outside surface of the diaper, wherein the first sensor electrode and the first electrode area constitute a first capacitor, and the second sensor electrode and the second electrode area constitute a second capacitor. Capacitance of the first and second capacitors is detected, and a radio frequency signal is generated as a wetness signal according to variation in the capacitance of the first and second capacitors.

### BRIEF DESCRIPTION OF DRAWINGS

The invention can be more fully understood by reading the subsequent detailed description and examples with references made to the accompanying drawings, wherein:

FIG. 1 is a schematic view of an embodiment of a urine detection system according to the invention;

FIG. 2 is a schematic view of the electrode of FIG. 1;

FIG. 3 is a schematic view of the sensor of FIG. 1;

FIG. 4 is a schematic view of the display unit of FIG. 1;

FIG. 5 is a flowchart of an embodiment of a urine detection method according to the invention;

FIGS. 6A and 6B are flowcharts of an embodiment of a method for analyzing wetness value according to the invention; and

FIG. 7 is a schematic view of the relationship between ΔW and time according to the invention.

### DETAILED DESCRIPTION

One or more specific embodiments of the invention are described below. In an effort to provide a concise description of these embodiments, not all features of actual implemented embodiments are described in the specification. It should be appreciated that in the development of any such actual implemented embodiments, as in any engineering or design project, numerous implementation-specific decisions must be made to achieve developer specific goals, such as compliance with system-related and business-related constraints, which may vary from one implementation to another. Moreover, it should be appreciated that such a development effort might be complex and time consuming, but would nevertheless be a routine undertaking of design, fabrication, and manufacturing for those of ordinary skill in the art, having the benefit of this disclosure.

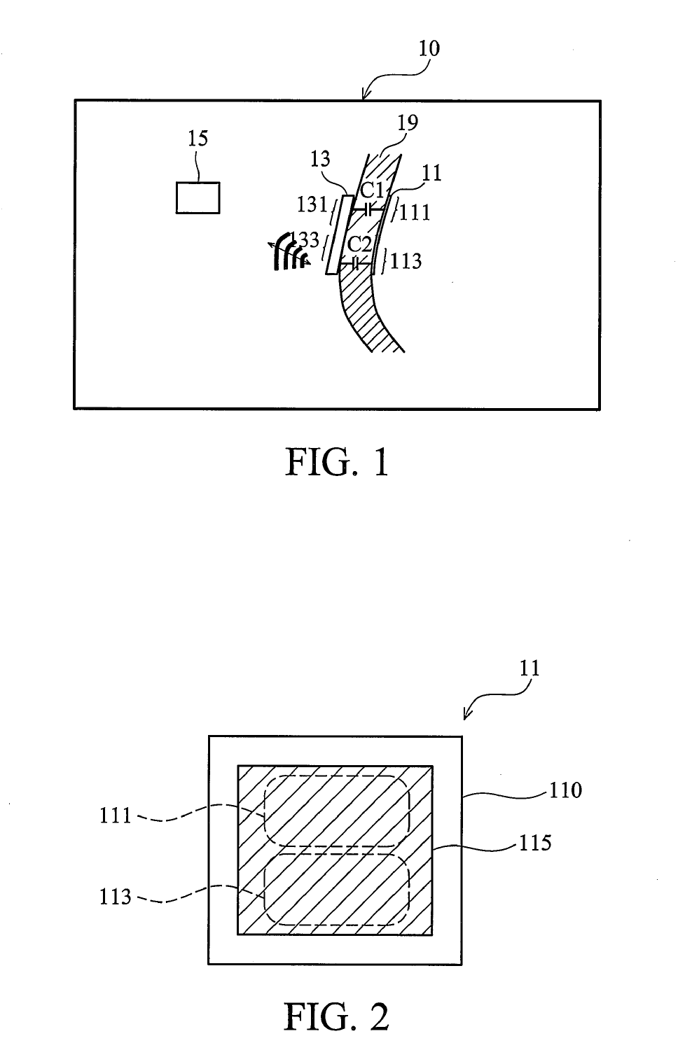

Following, the invention will be described with reference to FIGS. 1 through 7, which generally relate to urine detection. In the following detailed description, reference is made to the accompanying drawings which form a part hereof, shown by way of illustration of specific embodiments. These embodiments are described in sufficient detail to enable those skilled in the art to practice the invention, and it is to be understood that other embodiments may be utilized and that structural, logical and electrical changes may be made without departing from the spirit and scope of the present invention. The following detailed description is, therefore, not to be taken in a limiting sense. The reference numbers appearing in the figures correspond to a Figure Number. Meanwhile, the same reference number is used throughout to refer to an identical component which appears in multiple figures. It should be understood that many of the elements described and illustrated throughout the specification are functional in nature and may be embodied in one or more physical entities or may take other forms beyond those described or depicted.

FIG. 1 is a schematic view of an embodiment of a urine detection system according to the invention. Urine detection system 10 is configured to identify degree of wetness of a test subject 19, wherein the urine detection system 10 comprises an electrode 11, a capacitance sensor 13, and a display device 15.

Here, the test subject 19 is a diaper. Urine detection system 10 can be utilized in a domestic care or managed care environment, for monitoring the presence of urine in a diaper worn by infants or patients. In addition, the urine detection system 10 can be utilized in a remote health care environment.

The electrode 11 is a plane printing electrode, attached to or embedded in an inside surface of test subject 19 (diaper), i.e., contiguous to or near the body of the tested individual wearing the diaper. According to this embodiment, the diaper needs to be replaced by a new one when it has absorbed the designated maximum amount of urine. The attached or embedded electrode 11 is discarded together with the used diaper. Here, the electrode 11 is a simple plane printing electrode, since the electrode 11 is very cost effective, it does not cost much to use the electrode 11 in a disposable diaper.

FIG. 2 is a schematic view of the electrode 11 of FIG. 1. The electrode 11 comprises a flexible substrate 110 and a conductor 115 printed thereon, wherein the conductor 115 is comprised of conductive material. The flexible substrate 110 can be a paper substrate or a plastic substrate. The conductor 115 comprises an electrode area 111 and electrode area 113.

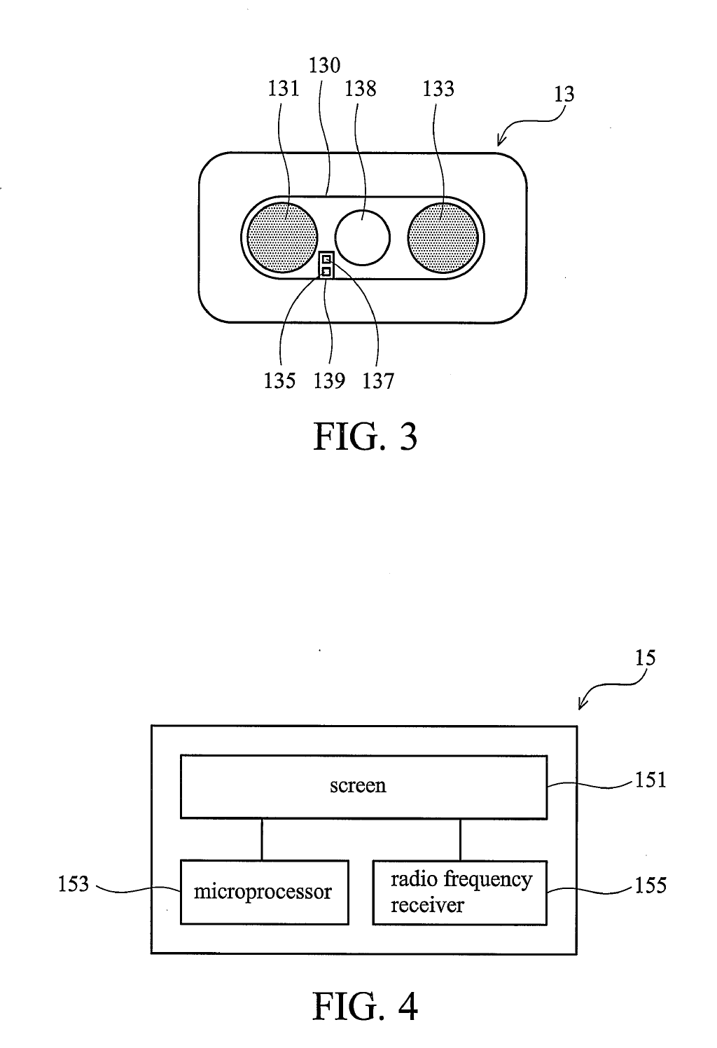

FIG. 3 is a schematic view of the sensor 13 of FIG. 1. Components of sensor 13 can be mounted on a flexible substrate 130. In addition, components of sensor 13 are packaged in flexible package material (not shown), thus the sensor 13 can be attached to an outside surface of test subject 19, such as a diaper.

The sensor 13 comprises a sensor electrode 131 and sensor electrode 133, wherein the sensor electrode 131 and electrode area 111 constitute a capacitor C1 (as shown in FIG. 1), and the sensor electrode 133 and electrode area 113 constitute a capacitor C2 (as shown in FIG. 1).

Referring to FIG. 2, conductor 115 is comprised of conductive material. Accordingly, electrode area 111 and electrode area 113 are electrically connected. Capacitor C1 and capacitor C2 operate as one single capacitor C, wherein C=C1*C2/(C1+C2).

The sensor 13 comprises a processor 135. The processor 135 detects capacitance of capacitor C1 and capacitor C2 (i.e., capacitor C), determines variation in the capacitance of capacitors C1 and C2, uses OOK (On/Off Keying) to modulate the variation and up-converts the variation to a radio frequency signal, and transmits the radio frequency signal as a wetness signal through a radio frequency transmitter 137.

According to this embodiment, radio frequency transmitter 137 and processor 135 are implemented by a single logic circuit 139.

The sensor 13 comprises a battery 138 as a power source for sensor 13 components.

FIG. 4 is a schematic view of the display unit 15 of FIG. 1. The display unit 15 comprises a screen 151, a microprocessor 153, and a radio frequency receiver 155.

The radio frequency receiver 155 receives the radio frequency signal sent from radio frequency transmitter 137, and transmits the radio frequency signal to microprocessor 153 for further processing. The microprocessor 153 converts the radio frequency signal to a corresponding wetness value, and directs screen 151 to display the wetness value.

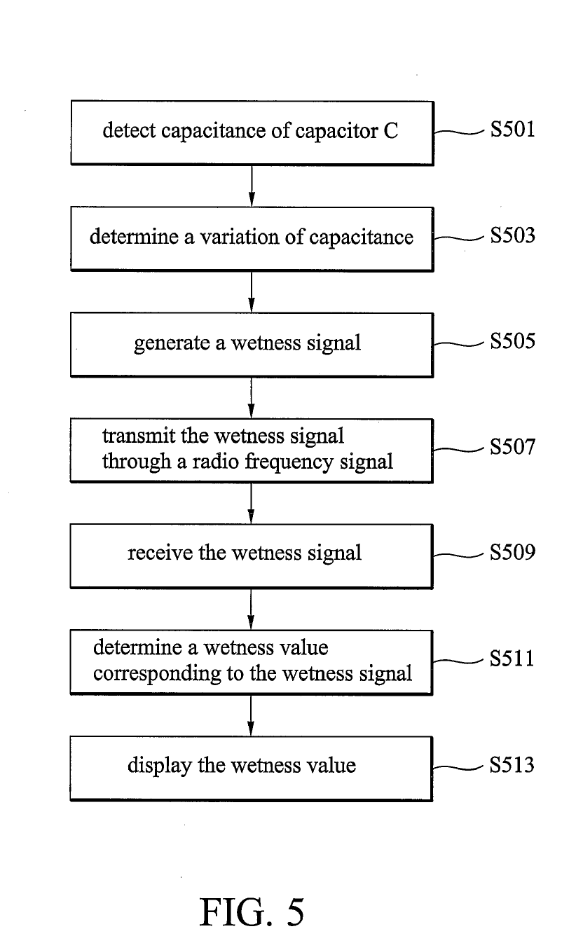

The microprocessor 153 can perform an analysis using the wetness value (see FIG. 5), and direct screen 151 to display results of the analysis. In addition, when the results of the analysis conform to a preset condition, a signal is generated to inform a care taker, wherein the signal can be implemented by a visual signal (such as a flash), an audio signal (such as a buzz) or other signals.

FIG. 5 is a flowchart of an embodiment of a urine detection method according to the invention. The method of FIG. 5 can be implemented in the urine detection system of FIG. 1.

In step S501, capacitance of capacitor C is detected. In step S503, the capacitance detected in step S501 is compared with a preset capacitance to determine a variation of capacitance, wherein the preset capacitance corresponds to a known degree of wetness. Here, the preset capacitance corresponds to degree of wetness of a diaper which has not been wetted.

In step S505, a wetness signal is generated according to the variation of capacitance.

In step S507, the wetness signal is transmitted through a radio frequency signal.

In step S509, the wetness signal is received. In step S511, a wetness value corresponding to the wetness signal is determined. In step S513, the wetness value is displayed on a display screen.

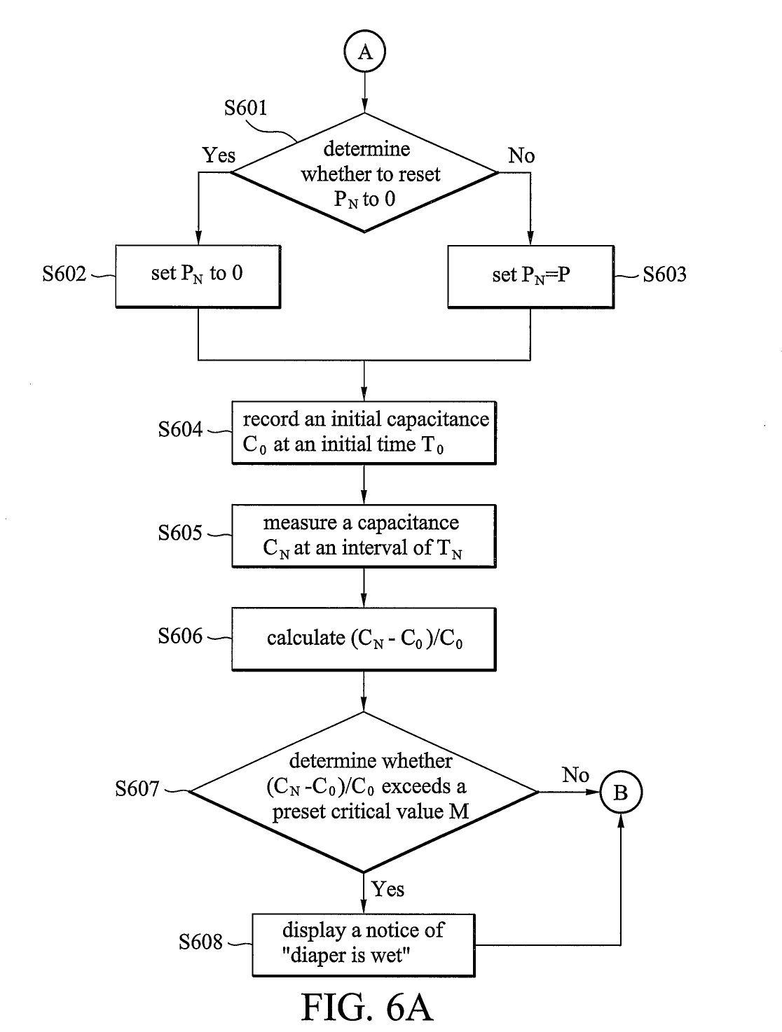

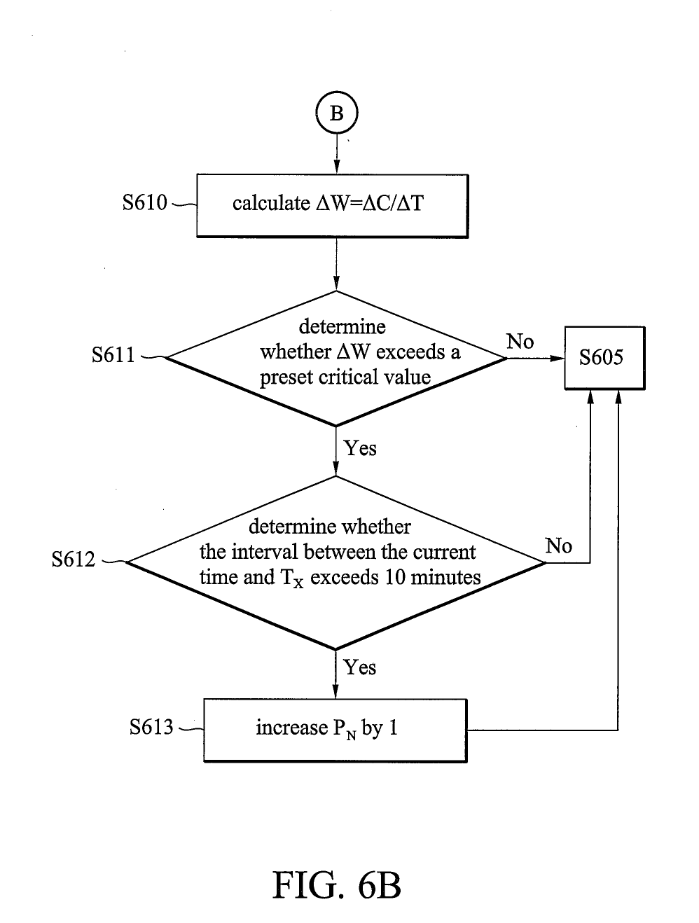

FIGS. 6A and 6B are flowcharts of an embodiment of a method for analyzing wetness value according to the invention. The method of FIGS. 6A and 6B can be executed by microprocessor 153, and results obtained through the method can be displayed on screen 151. The method for analyzing wetness value can be performed when replacing a used diaper with a new one.

A procedure A of FIG. 6A and a procedure B of FIG. 6B are performed to determine whether a diaper is wetted, and to record accumulated number of times of urine excretion during a particular period of time (such as a day).

In step S601, it is determined whether to keep a previously calculated number, representing cumulated number of times of urine excretion (P). In other words, it is determined whether to reset the accumulated number of times of urine excretion to zero, and if so, the method proceeds to step S602, otherwise, the method proceeds to step S603. In step S602, the accumulated number of times of urine excretion (P_{N}) is reset to zero. In step S603, the previously calculated number, representing cumulated number of times of urine excretion (P) is retrieved, and the cumulated number of times of urine excretion (P_{N}) is set as the previously calculated number, representing cumulated number of times of urine excretion (P). The cumulated number of times of urine excretion during a particular period of time can be calculated by performing steps S601-S603.

The microprocessor 153 implements a clock function for providing time signals for further use. In step S604, an initial capacitance C₀ at an initial time T₀ is recorded. In step S605, a capacitance C_{N} is measured at an interval of T_{N}.

In step S606, a value of (C_{N}−C₀)/C₀ is calculated. In step S607, it is determined whether the value of (C_{N}−C₀)/C₀ exceeds a preset critical value M, and of so, it is required that the test diaper is replaced with a new one, because the test diaper has absorbed the designated maximum amount of urine, and the method proceeds to step S608, otherwise, the method proceeds to procedure B. In step S608, a notice of “diaper is wet” is displayed, or other signals (audio or visual signals) are generated to inform a care taker.

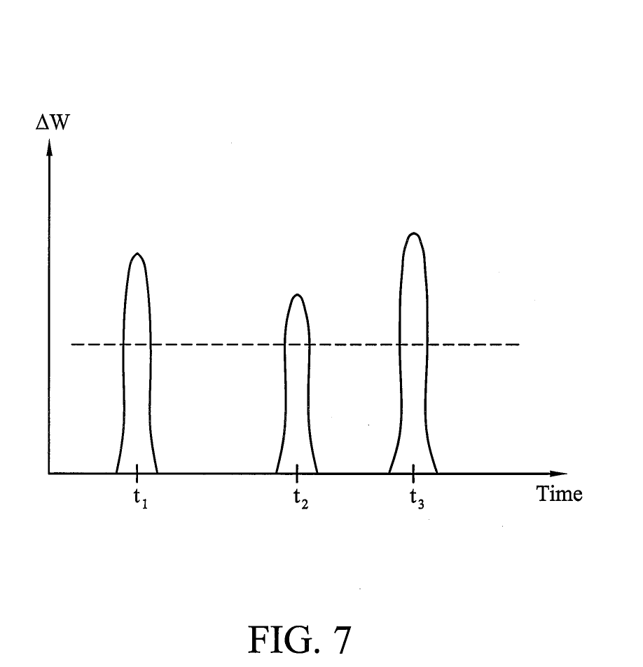

Referring to procedure B of FIG. 6B, in step S610, the measured capacitance is differentiated with respect to time, i.e., ΔW=ΔC/ΔT is calculated, wherein the AC equals to (C_{N}−C_{N-1}), and ΔT equals to (T_{N}−T_{N-1}). In step S611, it is determined whether ΔW exceeds a preset critical value. When ΔW exceeds the preset critical value, urine excretion is detected, otherwise, the method returns to step S605. FIG. 7 is a schematic view of relationship between ΔW and time. Referring to FIG. 7, ΔW is depicted by the vertical axis, and time is depicted by horizontal axis. When ΔW exceeds the critical value S, urine excretion is detected.

In addition, for an infant or other tested individual being trained to use a toilet, two urine excretion times may be detected over a short span of a few minutes. In this circumstance, urine excretions detected during a short span of time should be regarded as one excretion, thus more accurately representing number of times of excretion. Here, two excretions detected within 10 minutes are regarded as one excretion. In step S612, it is determined whether the interval between the current time and the time at which the previous excretion was detected (Tx) exceeds 10 minutes, and if so, the method proceeds to step S613, otherwise, the method returns to step S605. In step S613, the accumulated number of times of urine excretion (P_{N}) is increased by 1, and the method returns to step S605.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A urine detection system for identifying degree of wetness of a diaper, comprising:
a plane printing electrode, comprising a first electrode area and a second electrode area;
a sensor, comprising,
a first sensor electrode and a second sensor electrode, wherein the first sensor electrode and the first electrode area constitute a first capacitor, and the second sensor electrode and the second electrode area constitute a second capacitor, and
a processor detecting capacitance of the first and second capacitors, and determining a wetness signal representing the degree of wetness of the diaper; and
a display unit, receiving the wetness signal and displaying the degree of wetness corresponding to the wetness signal.

2. The urine detection system of claim 1, wherein the plane printing electrode is placed on an inside surface of the diaper, and the sensor is placed on an outside surface of the diaper.

3. The urine detection system of claim 1, wherein the plane printing electrode is printed on a flexible substrate.

4. The urine detection system of claim 3, wherein the plane printing electrode is printed on a paper substrate.

5. The urine detection system of claim 3, wherein the plane printing electrode is printed on a plastic substrate.

6. The urine detection system of claim 1, wherein the sensor comprises a flexible substrate.

7. The urine detection system of claim 6, wherein the first sensor electrode and the second sensor electrode is printed on the flexible substrate, and the sensor is packaged in flexible package material.

8. The urine detection system of claim 7, wherein the flexible package material comprises flexible material which is attachable to an outside surface of the diaper.

9. The urine detection system of claim 1, wherein the sensor further comprises a radio frequency transmitter, and the display unit comprises a radio frequency receiver, wherein the radio frequency transmitter, coupled to the processor, transmits the wetness signal to the display unit through a radio frequency signal, and the radio frequency receiver receives the radio frequency signal transmitted from the radio frequency transmitter.

10. The urine detection system of claim 9, wherein the radio frequency transmitter and the processor is implemented by a single logic circuit.

11. The urine detection system of claim 1, wherein the sensor further comprises a power source providing power to components of the sensor.

12. The urine detection system of claim 1, wherein the display unit further comprises a microprocessor, providing time information, and the display unit displays the time information.

13. The urine detection system of claim 12, wherein the display unit further comprises a microprocessor, determining the number of times the diaper is wetted, according to the wetness signal and the time information.

14. The urine detection system of claim 1, wherein the display unit further comprises a microprocessor, analyzing the wetness signal, and directing the display unit to display a warning indicator when the wetness signal reaches a preset value.

15. A urine detection method for identifying degree of wetness of a diaper, comprising:
providing a plane printing electrode on an inside surface of the diaper, wherein the plane printing electrode comprises a first electrode area and a second electrode area;
providing a first sensor electrode and a second sensor electrode on an outside surface of the diaper, wherein the first sensor electrode and the first electrode area constitute a first capacitor, and the second sensor electrode and the second electrode area constitute a second capacitor;
detecting capacitance of the first and second capacitors, and generating a radio frequency signal as a wetness signal according to variation in the capacitance of the first and second capacitors; and
receiving the wetness signal and displaying the degree of wetness corresponding to the wetness signal.

16. The urine detection method of claim 15, wherein the plane printing electrode is printed on a flexible substrate.

17. The urine detection method of claim 16, wherein the plane printing electrode is printed on a paper substrate.

18. The urine detection method of claim 16, wherein the plane printing electrode is printed on a plastic substrate.

19. The urine detection method of claim 15, wherein the first sensor electrode and the second sensor electrode is printed on the flexible substrate, and the sensor is packaged in flexible package material.

20. The urine detection method of claim 15, wherein the wetness signal is transmitted through a radio frequency signal.

21. The urine detection method of claim 15, further providing time information, and displaying the time information.

22. The urine detection method of claim 15, further determining the number of times the diaper is wetted according to the wetness signal and the time information.

23. The urine detection method of claim 15, further analyzing the wetness signal, and directing the display unit to display a warning indicator when the wetness signal reaches a preset value.
